(19) United States
(12) Patent Application Publication
(10) Pub. No.: US 2006/0170915 A1
(43) Pub. Date: Aug. 3, 2006

(54) Optical measurement substrate and method of manufacturing the same

(76) Inventors: Koichiro Nakamura, Tokyo (JP); Koji Fujita, Tokyo (JP); Koki Tanamura, Tokyo (JP); Yasunori Arima, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/341,857

(22) Filed: Jan. 30, 2006

(30) Foreign Application Priority Data
Jan. 28, 2005 (JP) P2005-022033

(51) Int. Cl. G01N 1/10

(52) U.S. Cl. 356/246

(57) ABSTRACT

A masking pattern is performed on a substrate by using materials that are weakly adhered to the substrate, and then the masked substrate is etched. Since the mask is weakly adhered to the substrate, the mask is peeled off from the surface of the substrate, so that a gap is generated between the mask and the substrate, and then anisotropic etching is performed. According to this method, it is possible to easily manufacture an optical measurement substrate having recesses whose sectional shape can be approximated to a curve having inflection points. Therefore, optical characteristics of a minute amount of substances can be evaluated efficiently without the loss of incident and reflected light even when measuring light is incident at an angle of less than 45 degrees.

### BACKGROUND OF THE INVENTION

1. Field of the Invention

The present invention relates to a substrate for holding samples, more particularly samples to be measured in optical measurement, a method of manufacturing the substrate and an optical measuring method using the substrate.

2. Related Art

In applications of organic materials or biological-related materials to electronic engineering field, practical use of products, to which technologies such as molecular electronics, molecular memory, nano-biotechnology, etc. are applied, has been highly expected. For this reason, not only should functional elements be highly integrated on a substrate (chip), but a minute amount of specific material should also be selectively adhered to or held at predetermined portions on the surface of the substrate with high accuracy.

In addition, in the bioscience field, functional elements have been highly integrated and highly dense-arrayed for an infinitesimal and extremely sensitive analysis that uses a micro chemical reactor, a chip for genomic analysis, a chip for protein analysis, etc. As a result, substrates used in the above field are required to function as a container for selectively holding a minute amount of material. In the above substrates, a liquid sample such as a minute amount of biological-related substance solution can be held selectively in predetermined portions, and thus can be provided for analysis and reaction.

Furthermore, in studying and developing novel functional substances (such as optical materials, medication, biological-related molecule, pesticide, etc.), a novel art called combinatorial chemistry has drawn attention. This art efficiently synthesizes various kinds of compound libraries by using many combinations and uses them according to various purposes. When many compound libraries are synthesized and evaluated, a minute amount of substances needs to be efficiently measured and analyzed. With respect to methods of measuring and analyzing the minute amount of substances, for example, transmission factor, chromaticity, refraction factor, polarization, etc. are measured in the case of optical materials.

Techniques forming joint regions of functional substances on the substrate with high density are disclosed in, for example, WO 94/27719 (Japanese Domestic Publication JP 09-500568A), JP 2002-131327A, JP 2002-307801A, JP 2002-283530A, JP 2003-121442A and JP 2002-125656A. In addition, a microtiter plate having a plurality of openings and recesses or the like have been well known as substrates that functions as a container (refer to JP-A-2002-125656).

However, in the methods disclosed in the related arts, since patterns are formed exclusively on a flat surface of a substrate, and a functional join site is located in a flat part, when a minute amount of liquid sample is held in a plurality of places on a surface of a substrate, there are problems in that the sample is not evenly held, and the reproducibility is bad. Furthermore, when the joint regions are highly integrated, a distance between adjacent joint regions becomes small, which causes adjacent liquid samples to become mixed.

In addition, when chemical materials are optically measured, generally, incident light is irradiated at an angle of 45 degrees to samples, and reflected light is detected. Since the microtiter plate disclosed in Patent Document 6 has a recess having a deep depth, when reflection factor and refraction factor are measured after a minute amount of sample, in which a solute is dissolved in a solvent, is measured and reacted to light, heat or chemical action, and then the sample is made thin by evaporating the solvent, if measuring light is incident at an angle lower than 45 degrees, the light touches a side wall, so that measurement cannot be performed. Furthermore, if the light is reflected from the sample at an angle lower than 45 degrees, the light touches the side wall, so that a detector cannot receive the reflected light.

### SUMMARY OF THE INVENTION

The present invention has been made in view of the drawbacks inherent in the related art, and it is an advantage of the invention to provide a selectively adherent substrate in which a minute amount of specific materials can be adhered to and held at a small regions of the substrate with high density and reproducibility, and the optical characteristics of the minute amount of substances can be evaluated efficiently with no loss of incident and reflected light even when the measuring light is incident at an angle lower than 45 degrees.

An aspect of the invention provides a substrate for holding samples, including a plurality of recesses formed on a surface of a substrate, in which a diameter of an approximated circle of an upper opening of the recess is larger than a diameter of an approximated circle of a bottom of the recess, and a side wall part of the recess can be approximated to a straight line inclined at an angle of 60 degrees or less, or a curve having at least one inflection point. The curve may be represented by the following equation.
y=a/[1+exp{−k(x−b)}]

x: coordinates in a horizontal direction

y: coordinates in a vertical direction

a: depth of recess; 0.1 μm<a<600 μm

b, k: constant number

A measuring method according to another aspect of the invention is a measuring method, light is incident on the surface of the substrate at an angle from 35 to 55 degrees in the recess, and then the light reflected from the recess is measured.

A method of manufacturing the optical measurement substrate according to still another aspect of the invention is a chemical etching method including a mask having a pattern provided on the surface of the substrate and forming the recesses on the substrate by contacting the substrate with etchant, in which a gap is formed between the surface of the substrate and the mask during etching, and the substrate is manufactured by anisotropic etching, in which etching speed in a horizontal direction of the substrate is larger than etching speed in a vertical direction of the substrate.

With the substrate of the invention, high-accuracy measurement can be performed by using incident measuring light at an angle lower than 45 degrees that is generally used in optical measuring. In particular, when incident light enters at an angle from 35 to 55 degrees, high-accuracy measurement can be preformed. In addition, in the substrate according to the invention, since the substrate holds samples in the recesses, adjacently located samples are prevented from mixing, compared with the flat substrate, therefore, the number of recesses on the substrate, that is, the number of held samples can be increased.

### BRIEF DESCRIPTION OF THE DRAWINGS

FIGS. 1A and 1B include schematic views illustrating a sectional shape of a recess. FIG. 1A illustrates a case in which the sectional shape of a side wall part of the recess can be approximated to a straight line, and FIG. 1B illustrates a case in which the sectional shape of the side wall part of the recess can be approximated to a curve;

FIGS. 2A and 2B include schematic views illustrating etching states. FIG. 2A illustrates isotropic etching, and FIG. 2B illustrates anisotropic etching;

FIGS. 3A and 3B includes schematic views illustrating etching methods for forming the recess of the invention, in which FIG. 3A illustrates an ongoing state of etching, and FIG. 3B illustrates the sectional shape of the recess after etching;

FIG. 4 is a cross-sectional view showing a mold and a part of a substrate according to the invention;

FIG. 5 is a cross-sectional view showing the mold and a part of the substrate according to the invention;

FIG. 6 is a cross-sectional view showing a mold and a part of a substrate according to the related art;

FIG. 7 is a cross-sectional view showing the mold and the part of the substrate according to the related art;

FIGS. 8A and 8B include schematic views illustrating an example of a substrate according to the invention, in which FIG. 8A is a top surface view of the substrate, and FIG. 8B is a cross-sectional view of the substrate taken from a line VIIIB-VIIIB of FIG. 8A;

FIG. 9 is a schematic view illustrating an example of a measuring method according to the invention;

FIG. 10 is a schematic view illustrating another example of the measuring method according to the invention;

FIG. 11 is a schematic view illustrating an example of methods of measuring according to the related art;

FIG. 12 is a schematic view illustrating another example of the measuring method according to the related art; and

FIG. 13 is a graph illustrating measured values and calculated values of the sectional shape of the recess according to the invention.

### DETAILED DESCRIPTION OF THE PREFERRED EMBODIMENTS

Hereinafter, preferred embodiments of the present invention will be described.

A measurement substrate of the invention includes a plurality of recesses arranged thereon at predetermined intervals. The recesses are formed on a substantially flat surface of the substrate at predetermined intervals. Adjacent recesses can be arranged with intervals therebetween and without intervals. The recesses are formed by processing the substrate. In order to ensure measurement accuracy, the substrate is preferably homogeneous. When a glass substrate is used, it is possible to easily form recesses arranged with a predetermined rule by forming recesses directly on the surface of the glass substrate. In addition, when a resin substrate is used, it is possible to easily form recesses arranged with a predetermined rule with a method such as injection molding or the like.

Materials to be used for making the substrate of the invention include, for example, glass, ceramics, semiconductor, metal, resin, etc. The types of glass which can be used in manufacturing the substrate include silica glass (coefficient of linear thermal expansion α=0.5 ppm/K), no-alkali glass (for example, NA35 manufactured by ASAHI TECHNO GLASS Corp. or the like), soda lime glass, zerodur (registered trademark) (manufactured by SCHOTT, α=−2 ppm/K), low expansion crystallized glass (for example, NEOCERAM manufactured by Nippon Electric Glass Co., Ltd, α=0.15 ppm/K), Pyrex (registered trademark) (manufactured by CORNING, α=3.25 ppm/K), BK7 (manufactured by SCHOTT, α=7.1 ppm/K), etc.

Furthermore, semiconductor materials such as silicon, InP, GaAs provided in a wafer form are available. Resin materials, such as epoxy resin, acryl resin, polycarbonate resin, polyimide resin, fluorine resin can be used. Among the above materials, glass is most preferable since glass is superior in heat resistance, transparency, chemical stability, and organic solvent resistance.

Now, the shape of the recesses formed on the substrate will be described. The recesses function as a so-called container which holds samples. The recesses can be formed in various shapes, such as spherical recess, circular cone, triangular pyramid, quadrangular pyramid, groove, circular cylinder, line, Y-branch line or the like. When the recesses are formed in the shapes of spherical recess, circular cone, triangular pyramid, quadrangular pyramid, groove, circular cylinder or the like, the density of the substrate is set to have 4 or more recesses per substrate area of 1 cm², and when the substrate is used as a high density integrated substrate, the density of the substrate is preferably set to have 100 or more recesses per 1 cm², and more preferably set to have 10,000 or more recesses per 1 cm². In addition, when the recesses are formed in the shapes of groove, line, and Y-branch line, a line width is set to be 3000 or less μm, preferably to be 10 or lower μm. Accordingly, a substrate having a high density minute pattern structure can be obtained so as to be used as a highly integrated substrate.

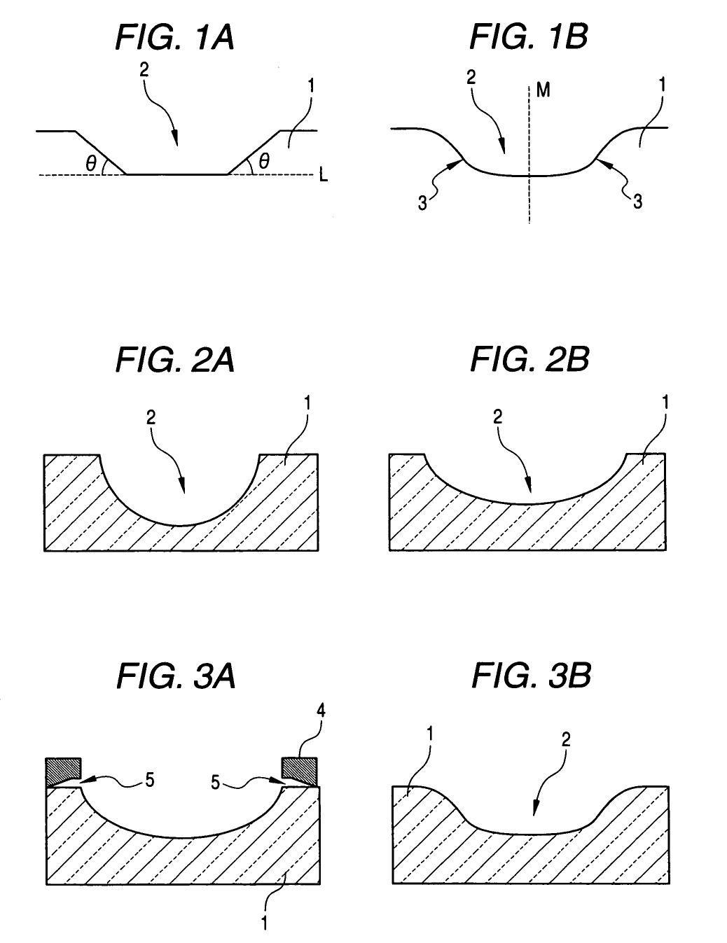

When the opening and the bottom of the recesses are approximated to a circle, the diameter of the opening is larger than the diameter of the bottom. The sectional shape of a side wall part of the recess is approximated to a straight line inclined at an angle lower than 60 degrees or a curve having inflection points. As shown in FIG. 1A, when the bottom is approximated to a straight line L, a inclination means an angle θ between the line L and the approximate line of the side wall part. The side wall part can be approximated to curve means that the respective side wall parts on both sides of a center line M can be approximated to curves having one or more inflection points 3 as shown in FIG. 1B. This does not mean that the entire recess can be approximated to curve. For example, in the case of the sectional shape of the recess shown in FIG. 2A does not have any inflection point. Even though FIGS. 1A and 1B show a symmetrical structure of the side wall parts with respect to the center line, the shape of the recess need not have a symmetric structure with respect to the center line as long as the sectional shape of the side wall part can be approximated to a straight line inclined at an angle lower than 60 degrees or a curve having at least one inflection point.

If the approximate curve is a curve represented by the following equation (1), it is preferable since measuring light to be incident and detecting light to be reflected becomes difficult to block. The shaped of the recess such as height and width can be properly designed according to the use of the measurement substrate.
y=a/[1+exp{−k(x−b)}] (1)

x: coordinates in a horizontal direction

y: coordinates in a vertical direction

a: depth of recess; 0.1 μm<a<600 μm

b, k: constant number

Next, a method of manufacturing the measurement substrate of the invention will be described. When the substrate is made of glass, the substrate can be manufactured by glass molding, sol-gel molding, chemical etching, or the like.

[Glass Press Molding]

After heating glass up to about 800° C. to 1000° C., the heated glass is pressed by a mold having a predetermined shape. It is possible to manufacture the measurement substrate of the invention by press-molding the heated glass with the mold having the reversed shape of desired recess.

[Sol-Gel Press Molding]

After metal alkoxide such as tetraethoxysilane or the like is hydrolysis-hydrolyzed in the presence of an acid or alkaline catalyst and then dehydration-condensed. The surface of the substrate is coated with the obtained solution, or the mold comes into contact with the solution as a bulk body. Afterwards, the solution is heated so as to be vitrified, and then the measurement substrate having the reversed shape of the mold can be manufactured.

In addition, a modification of the Sol-gel press molding, for example, recesses can be regularly formed by patterning ink or the like on the substrate. Black paint used as a mask in etching the substrate can be used as the ink.

[Chemical Etching]

In the chemical etching, a solid body is etched by bringing a water solution (etching liquid) containing ingredients (etchant) that dissolve the solid body to the surface of the solid body. The substrate to be etched can be glass, ceramics, semiconductor, metal, resin, etc.

The etching liquid can be selected from fluorinated acid, sulfuric acid, nitric acid, fluorinated acid buffer solution, phosphoric acid, hydrogen peroxide solution, ammonium fluoride, sodium hydroxide, potassium hydroxide, mixed liquid thereof, etc. according to the types of the substrate.

When a minute pattern is formed on glass by the chemical etching, a minute pattern mask is formed on the glass by methods such as photolithography or the like. Since the mask has etching resistance to etchant, the etchant such as fluorinated acid or the like exclusively etches non-masked parts (the surface of the glass), and consequently, a spherical recess is formed.

In the measuring container of the invention, the sectional shape of the side wall part of the recess can be approximated to a curve having inflection points. In order to form the above sectional shape by etching, anisotropic etching is performed.

In the case of common glass etching, isotropic etching, in which the etching speed in the vertical direction is equal to the etching speed in the horizontal direction, is performed on the parts, with which the etchant comes into contact (disclosed in detail in JP-A-3-23273). When isotropic etching is performed, the sectional shape of the recess becomes a half circle as shown in FIG. 2A so that the radius of the recess becomes constant. On the other had, when the etching speed in the horizontal direction is larger than the etching speed in the vertical direction, an elliptic, in which the depth is shorter than the width, is obtained as shown in FIG. 2B.

After obtaining the shape shown in FIG. 2B by anisotropic etching, the recess whose sectional shape can be approximated to a curve having inflection points as shown in FIG. 3B can be obtained by further performing anisotropic etching.

As an anisotropic etching, there is a method in which the composition of the substrate is varied part by part, and thus the substrate is etched as different etching speed part by part. For example, by doping fluorine on the surface of the substrate, etching is performed slowly in the vertical direction and etching is performed fast in the horizontal direction. Besides, the etching speed can be varied by forming a distribution in the alkali contents in the solution.

As a method of performing anisotropic etching without varying the composition of the substrate, there are following methods. First, a masking pattern is formed on the substrate. At this time, the mask is formed with materials weak in the adhesion to the substrate. When the masked substrate is etched, since the mask is weakly adhered to the substrate, the mask 4 is peeled off from the surface of the substrate as shown in FIG. 3A, so that a gap 5 is generated between the mask 4 and the substrate 1. And then, since the etching liquid sneaks into the gap 5 and the substrate is etched from the gap 5 the etching speed in the horizontal direction becomes larger than the etching speed in the vertical direction, and anisotropic etching is performed. With this method, it is possible to easily form the recess shape that can be approximated to a curve, in which the sectional shape has inflection points as shown in FIG. 3B.

The mask can be made of any materials as long as the materials are not etched by the etchant and easily removed after patterning and etching. Since a mask pattern formed by sputtering materials such as Cr, Au or the like is heavily adhered to a substrate, the mask is not suitable for the above, however, for example, if the thin layer of Cr and Au is made thinner and proper etching liquid is selected, the layer becomes easy to be peeled off, and then anisotropic etching can be performed.

Samples are measured by using the measurement substrate obtained by the above methods. The substrate of the invention can be used in any device if the device is an optical measuring device. The refraction factor of the samples can be measured by inputting the measuring light to the samples at an angle of about 35 or more degrees and using reflected light that is reflected at an angle of about 35 or more degrees among the detecting light reflected from the samples. Even though the incident angle of the measuring light can be selected by a measuring device, the angle is preferably in the range of about 35 degrees to about 55 degrees in order to minimize the reflection of the light by side walls.

Hereinafter, examples will be described in greater detail.

### EXAMPLE 1

(Manufacturing Measurement Substrate)

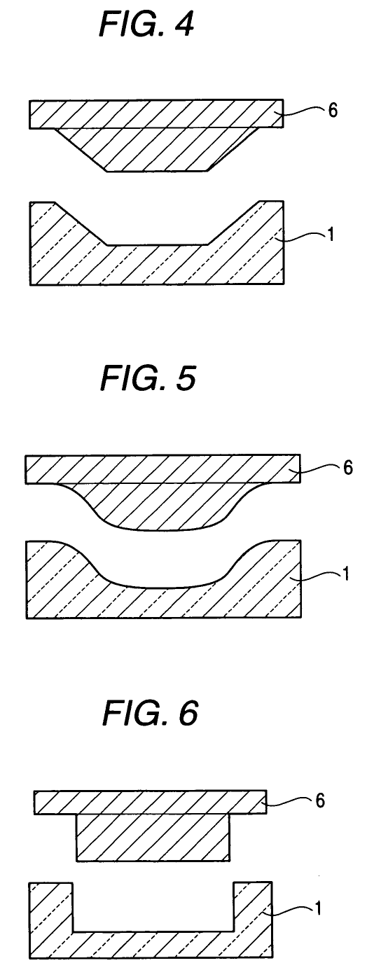

In the present example, the recess is formed by glass press molding. Glass is heated up to 800° C. and then pressed by a glass press mold (having 50 protrusions (5 rows×10 columns); peak diameter of protrusion: 2.0 mm, height of protrusion: 500 μm, inclination: 45 degrees). After that, the glass is cooled and then separated from the mold. The protrusion of the mold is shown in FIG. 4. The obtained measurement substrate has 50 recesses (5 rows×10 columns=50; inclination: 45 degrees, diameter of opening: 3 mm, height: 500 μm) as shown in FIG. 4.

(Measuring Sample Using Measurement Substrate)

2 μl of solution containing 10 parts by mass of acrylic acid estermonomer dissolved in 100 parts by mass of acetone is dropped on the recess of the measurement substrate and then heated up to 100° C. The solvent is evaporated and the solution is cured so as to form a homogeneous film (sample) at the bottom of the recess. Light is incident on the surface of the film with He—Ne laser beam (wavelength; 633 nm) at an angle of 45 degrees, and then intensity of the reflected light is measured. Table 4 shows measured intensities which are calculated upon the condition that the intensity measured when a film is formed on a flat substrate by the above method and the intensity of the reflected light is measured as described above is set to 1. As shown in FIG. 9, since incident light and reflected light indicated by dotted lines are not blocked by the side wall part of the recess, every light component reflected from the entire surface of a sample 7 can be detected, so that the same intensity as that of the flat substrate can be obtained.

### EXAMPLE 2

(Manufacturing Measurement Substrate)

In the present example, the recess is formed by the glass press molding. The substrate of Example 2 is manufactured in the same manner as that of Example 1, except that a mold 6 having the sectional shape that can be approximated to a curve having inflection points shown in FIG. 5 is used instead of the mold shown in FIG. 4.

(Measuring Sample Using Measurement Substrate)

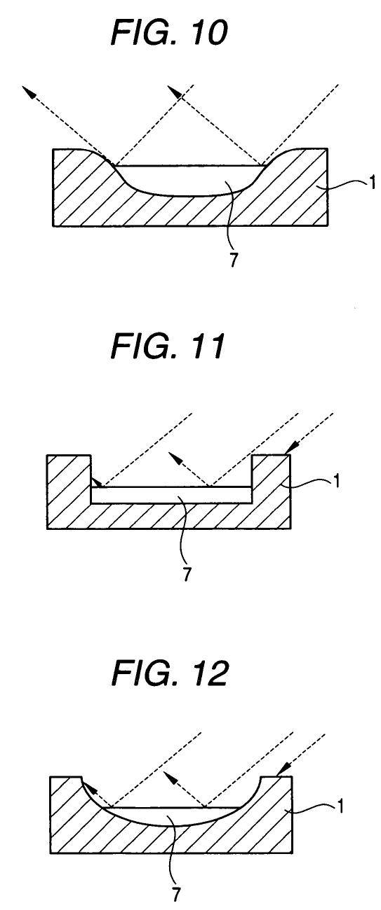

Measurement is performed in the same manner as that of Example 1. As shown in FIG. 10, since incident light and reflected light indicated by dotted lines are not blocked by the side wall part of the recess, the same measuring intensity as that of the flat substrate can be obtained as illustrated in Table 4.

### COMPARATIVE EXAMPLE 1

(Manufacturing Measurement Substrate)

In the present example, the recess is formed by the glass press molding. The substrate in the present example is manufactured in the same manner as that of Example 1, except that the mold (having 50 protrusions (5 rows×10 columns=50); peak diameter of protrusion: 2.0 mm, height of protrusion: 500 μm, inclination: 90 degrees) shown in FIG. 6 is used instead of the mold shown in FIG. 4.

(Measuring Sample Using Measurement Substrate)

Measurement is performed in the same manner as that of Example 1. The results are represented by Table 4. Since the inclination of the side wall part of the recess is 90 degrees, incident light and reflected light indicated by dotted lines are blocked by the side wall part as shown in FIG. 11, therefore, light reflected from the samples located at corners of the recess cannot be detected, and thus enough measuring intensity cannot be obtained.

### COMPARATIVE EXAMPLE 2

(Manufacturing Measurement Substrate)

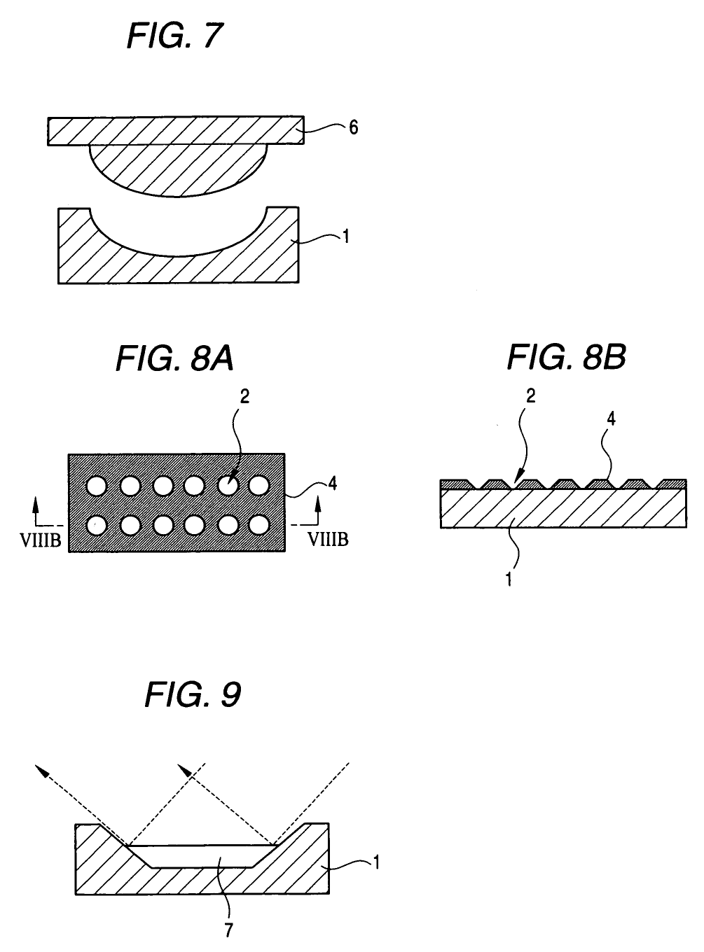

In the present example, the recess is formed by glass press molding. The substrate in the present example is manufactured in the same manner as that of Example 1, except by using the mold having a protrusion whose sectional shape cannot be approximated to a curve having at least one inflection point, as shown in FIG. 7, instead of using the mold shown in FIG. 4.

(Measuring Sample Using Measurement Substrate)

Measurement is performed in the same manner as that of Example 1. The results are represented by Table 4. Since incident light and reflected light indicated by dotted lines are blocked by the side wall part as shown in FIG. 12, light reflected by the samples located at corners of the recess cannot be detected, and thus enough measuring intensity cannot be obtained.

### EXAMPLE 3

(Manufacturing Measurement Substrate)

In Example 3, the recess is formed by the sol-gel press molding. The substrate in the present example is manufactured in the same manner as that of Example 1 except that the glass substrate on which a film is formed with ethanol water solution of tetraethoxysilane that is hydrolysis-hydrolyzed is used instead of a glass substrate.

(Measuring Sample Using Measurement Substrate)

Measurement is performed in the same manner as that of Example 1. The results are represented by Table 4, and the same measuring intensity as that of the flat substrate can be obtained.

### EXAMPLE 4

(Manufacturing Measurement Substrate)

In the present example, the recess is formed by the sol-gel press molding. A non-alkali glass substrate (NA35, NH manufactured by ASAHI TECHNO GLASS Corp., thickness: 1.1 mm, dimension: 25 mm×75 mm) which has been washed is coated with paint by screen printing.

Black paint containing carbon black, thermoplastic resin, pigment and solvent (hydrocarbon petroleum-based high boiling point solvent) as the main components is used as the paint. The composition of the black paint is represented by a Table 1 (C1 to C4)

TABLE 1
Composition (% by mass)

| | | | | | | High |
|---|---|---|---|---|---|---|
| | | | | | | boiling |
| Black | Thermoplastic | | | Carbon | | point |
| paint | resin | Paraffin | Pigment | black | Silica | solvent |
| C1 | 40 | 5 | 0 | 1-10 | 5 | 30 |
| C2 | 40 | 5 | 10 | 5 | 5 | 30 |
| C3 | 20 | 0 | 50 | 5 | 0 | 20 |
| C4 | 30 | 5 | 40 | 5 | 0 | 20 |

50 circular patterns (50=5 rows×10 columns, diameter=2.0 mm, pitch=4 mm) are formed on a screen. As shown in FIG. 8A, 50 circular non-coated parts (diameter=2.0 mm, pitch=4 mm) are formed on the substrate 1 coated with the black paint 4. The substrate is dried for 30 minutes in a hot air circulation reactor which is heated up to 100° C. Ultrasonic treatment is performed on the substrate in ethanol for 5 minutes, in 0.1 mole per letter of KOH solution for 5 minutes, and in ultrapure water for 5 minutes sequentially so as to obtain a substrate having recesses.

When a step between the circular non-coated part and the coated part around the circular non-coated part is measured by a stylus type thickness measuring device, the black paint 4 has a thickness of 20 μm. The sectional shape of the black paint-coated recess can be approximated to a straight line inclined at an angle of 45 degrees.

(Measuring Sample Using Measurement Substrate)

Measurement is performed in the same manner as that of Example 1. The results are represented by Table 4, and the same measuring intensity as that of the flat substrate can be obtained.

### EXAMPLE 5

(Manufacturing Measurement Substrate)

In the present example, the recess is formed by the chemical etching. The substrates coated with the black paint C1 to C4 obtained in Example 4 are indicated by D1 to D4. In the present example, the black paint is used as a mask so as to perform etching. Hydrofluoric acid solution is used as the etchant.

Contact angles of parts of the respective substrates D1 to D4 coated with the black paint and parts that are not coated with the black paint respect to water are measured and represented by Table 2. It is verified that the contact angle of coated portions with the black paint with respect to water is 110 or more degrees, and the contact angle of the surface of glass parts that are not coated with the black paint respect to water is below 10 degrees and 80 or more degrees. Therefore, it can be understood that hydrofluoric acid solution, the etchant, etches not the coated portions with the black paint, but only parts that are not coated with the black paint.

TABLE 2

| | | | | Transmission | |
|---|---|---|---|---|---|
| | | Contact angle (°) | | factor | |
| | Black | Coated | Uncoated | Coated | Uncoated |
| Substrate | paint | portions | portions | portions | portions |
| D1 | C1 | 110 | <10 | 0 | 90 |
| D2 | C2 | 112 | <10 | 0 | 90 |
| D3 | C3 | 114 | <10 | 0 | 90 |
| D4 | C4 | 112 | <10 | 0 | 90 |

After the substrates D1 to D4 are washed with ultrapure water (specific resistance: 18 MΩ·cm), the substrates are immersed in a mixture of 20% by mass of hydrofluoric acid, 2% by mass of ethylenediaminetetraacetic acid and 0.5% by mass of sodium dodecylbenzenesulfonate, and then etched for about 4 hours. The etching speed in the horizontal direction is twice larger than the etching speed in the vertical direction. After the etching, the substrates are washed with ultrapure water. The obtained substrates are indicated by E1 to E4. When a step between a flat part of the glass substrate and an etched part is measured with a stylus type thickness measuring device, the thickness is 420 μm for all substrates.

The obtained substrates are washed with black paint-peeling liquid so as to remove the black paint, and a measurement substrate is obtained. The measurement substrate has the depth of 400 μm and the opening diameter of 4.0 mm, in addition, the measurement substrate has a shape, that is, the sectional shape of the side wall part can be approximated to a curve having inflection points (See FIG. 3).

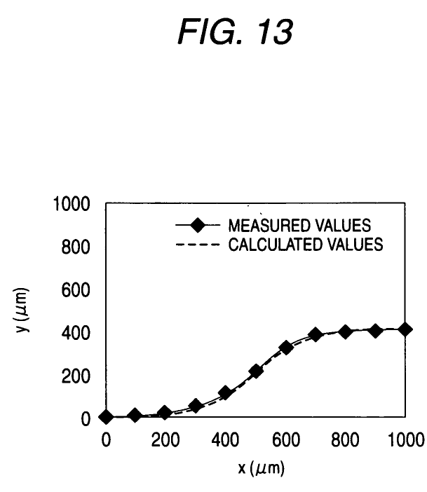

The sectional shape of the recess of the obtained substrate is observed by an optical microscope and represented by coordinates (x, y) (see Table 3) The sectional shape coincides to a curve (see FIG. 13) derived from Equation (1) when a=400 μm, b=500 μm, k=0.012 μm. The calculated coordinates of the curve are represented by Table 3.

TABLE 3

| | y (measured values) | y′ (calculated values) |
|---|---|---|
| x (μm) | (μm) | (μm) |
| 0 | 0 | 1 |
| 100 | 10 | 3 |
| 200 | 20 | 11 |
| 300 | 50 | 33 |
| 400 | 110 | 93 |
| 500 | 210 | 200 |
| 600 | 320 | 307 |
| 700 | 380 | 367 |
| 800 | 390 | 389 |
| 900 | 395 | 397 |
| 1000 | 400 | 399 |

(Measuring Sample Using Measurement Substrate)

Measurement is performed in the same manner as that of Example 1. The results are represented by Table 4, and the same measuring intensity as that of the flat substrate can be obtained.

TABLE 4

| Examples | Intensity of reflected light |
|---|---|
| Example 1 | 1 |
| Example 2 | 1 |
| Example 3 | 1 |
| Example 4 | 1 |
| Example 5 | 1 |
| Comparative Examples | |
| Comparative Example 1 | 0.5 |
| Comparative Example 2 | 0.45 |

What is claimed is:

1. A substrate for holding samples, comprising;
a plurality of recesses formed on a surface of a substrate,
wherein a diameter of an approximated circle of an upper opening of each recess is larger than a diameter of an approximated circle of a bottom of said recess, and a sectional shape of a side wall part of said recess is formed to be approximated to a straight line inclined at 60 degrees or less.

2. An optical measurement substrate according to claim 1, wherein the recesses are arranged on the substrate at regular intervals.

3. A measuring method using a substrate according to claim 1, wherein light is incident on the surface of the substrate at an angle from 35 to 55 degrees in the recess, and light reflected from the recess is measured.

4. A substrate for holding samples comprising,
a plurality of recesses formed on a surface of a substrate,
wherein a diameter of an approximated circle of an upper opening of each recess is larger than a diameter of an approximated circle of a bottom of said recess, and a sectional shape of a side wall part of said recess is formed to be approximated to a curve having at least one inflection point.

5. An optical measurement substrate according to claim 4, wherein the curve is represented by the following equation.
y=a/[1+exp{−k(x−b)}]
x: coordinates in a horizontal direction
y: coordinates in a vertical direction
a: depth of recess; 0.1 μm<a<600 μm
b, k: constant number

6. The optical measurement substrate according to claim 4, wherein the recesses are arranged on the substrate at regular intervals.

7. A measuring method using a substrate according to claim 4, wherein light is incident on the surface of the substrate at an angle from 35 to 55 degrees in the recess, and light reflected from the recess is measured.

8. A method of manufacturing a substrate according to claim 4, wherein a chemical etching is performed on the substrate on a surface of which a mask having a pattern is provided and which comes into contact with etchant so as to form the recesses on the substrate,
wherein a gap is formed between the surface of the substrate and the mask during etching, and an etching speed in a horizontal direction of the substrate is larger than an etching speed in a vertical direction of the substrate.

9. The method of manufacturing the substrate according to claim 8,
wherein the etching speed in the horizontal direction of the substrate is 1.5 times or more larger than the etching speed in the vertical direction of the substrate.
